(19) United States
(12) Patent Application Publication
(10) Pub. No.: US 2024/0336304 A1
(43) Pub. Date: Oct. 10, 2024

(54) ASSEMBLY FOR LOAD DISTRIBUTION IN A VEHICLE

(71) Applicant: AUDI AG, Ingolstadt (DE)

(72) Inventors: Kim Anne LIESERT, Ingolstadt (DE); Tanja HOEVEKAMP, Bietigheim-Bissingen (DE)

(73) Assignee: AUDI AG, Ingolstadt (DE)

(21) Appl. No.: 18/681,917

(22) PCT Filed: Aug. 9, 2022
(86) PCT No.: PCT/EP2022/072324

§ 371 Date: Feb. 7, 2024

(30) Foreign Application Priority Data
Oct. 5, 2021 (DE) 10 2021 125 737.9

(51) Int. Cl. B62D 21/15; B62D 27/02; B62D 27/06

(52) U.S. Cl. CPC B62D 21/152; B62D 27/023; B62D 27/06

(57) ABSTRACT

An arrangement for load distribution in a vehicle, having a longitudinal member designed as a hollow profile, a fastening sleeve, and a cross member which has at least one fastening flange, as well as a vehicle having such an arrangement. Here, the at least one fastening flange of the cross member extends at least in some sections parallel to the longitudinal member and is connected to the fastening sleeve. The fastening sleeve is inserted into the longitudinal member and connected in a formfitting manner to the longitudinal member, the fastening sleeve extends parallel to the cross member and introduces acting tensile loads into the longitudinal member.

### FIELD

The invention relates to an arrangement for load distribution in a vehicle. The invention furthermore relates to a vehicle having such an arrangement for load distribution.

### BACKGROUND

Arrangements for load distribution in a vehicle, in particular in a front section of the vehicle, are known in numerous variations. In order for a longitudinal member of the front section of the vehicle to dissipate energy in the event of an impact with a deformable obstacle, even if it is not directly in the impact area, such as in the case of a laterally offset impact with a deformable obstacle or in the case of a front pole impact, the longitudinal member is to be and remain connected to the affected components. This allows the load to be distributed over more components and the load on the affected components to be reduced. Since the longitudinal member is not directly hit in such an impact, it initially remains undeformed. Since the longitudinal member is not initially deformed, the tensile load on the connection between the undeformed longitudinal member and the components affected by the impact increases. As a result, the conventional connection technology can fail, meaning that the composite component cannot be held together.

A reinforcing element for reinforcing a hollow profile formed from longitudinal and lateral surfaces is known from DE 10 2012 022 876 A1. The reinforcing element has a bolt section and a head section. It is provided here that the bolt section has at least one pair of axially offset and protruding arm sections which are opposite to the bolt section and each have a contact surface at the end, and the bolt section having the arm sections is designed for insertion into the hollow profile interior via an insertion opening arranged on a lateral surface of the hollow profile, such that when the head section bears on this lateral surface, the end contact surfaces of the arm sections can be brought into contact with the inner surfaces of the longitudinal surfaces of the hollow profile by a rotational movement into an assembly position. In addition, a hollow profile having such a reinforcing element is disclosed.

A motor vehicle is known from DE 10 2019 131 552 A1, which comprises a body having two longitudinal members, on each of the front ends of which viewed in the direction of travel a baffle plate is placed, and a cross member which is fastened to the baffle plates. Here, an auxiliary frame connecting the baffle plates is fastened to the baffle plates.

### SUMMARY

The invention is based on the object of providing an arrangement for load distribution in a vehicle and a vehicle having such an arrangement which improves the cohesion of a connection technology between a longitudinal member designed as a hollow profile and a cross member in case of a crash. In order to provide an arrangement for load distribution in a vehicle, which improves the cohesion of a connection technology between a longitudinal member designed as a hollow profile and a cross member in case of a crash, the cross member has at least one fastening flange, which extends parallel to the longitudinal member at least in some sections. In addition, a fastening sleeve is provided to which the fastening flange is connected. Here, the fastening sleeve is inserted into the longitudinal member and connected to the longitudinal member in a formfitting manner such that the fastening sleeve extends parallel to the cross member and introduces acting tensile loads into the longitudinal member.

In addition, a vehicle is proposed having a longitudinal member designed as a hollow profile and a cross member, which are connected to one another via such an arrangement for load distribution. An arrangement for load distribution in a vehicle is understood hereinafter to mean an arrangement having a longitudinal member and a cross member connected to the longitudinal member, in which the connection technology between the cross member and the longitudinal member is relieved in that the fastening sleeve is introduced into the longitudinal member and the components affected in the event of a frontal impact are additionally connected to the fastening sleeve. In order that all of the energy does not have to be dissipated via this connection, the fastening sleeve is inserted into the longitudinal member in the direction of tension and is connected thereto in a formfitting manner. The energy is distributed to the walls of the longitudinal member via the form fit for optimal energy dissipation.

In an advantageous embodiment of the arrangement, the fastening sleeve can pass through a first opening in an inner wall of the longitudinal member and a second opening in an outer wall of the longitudinal member. For this purpose, the fastening sleeve can have a support plate at one end, which rests on the edge of the first opening and can form a first formfitting connection with the inner wall of the longitudinal member. The first form fit allows the tensile load to be distributed to the inner wall of the longitudinal member in case of a crash. Here, the inner wall is formed on a side of the longitudinal member facing toward the vehicle interior. In addition, the fastening sleeve can have a shoulder at the other end, which rests on the edge of the second opening and can form a second form fit with the outer wall of the longitudinal member. The second form fit additionally allows the tensile load to be distributed to the outer wall of the longitudinal member in case of a crash. Here, the outer wall is formed on a side of the longitudinal member facing away from the vehicle interior. Since the fastening sleeve is inserted into the longitudinal member in the traction direction, the fastening sleeve is first inserted into the first opening in the inner wall and then into the second opening in the outer wall. This enables a secure form fit between the fastening sleeve and the longitudinal member.

In a further advantageous embodiment of the arrangement, the at least one fastening flange can comprise a fastening tab. The fastening tab can preferably be screwed to the fastening sleeve at one end. This allows the form fit between the fastening sleeve and the longitudinal member to be strengthened. At the other end, the fastening tab can preferably be welded to the cross member.

The features and combinations of features mentioned above in the description as well as the features and feature combinations mentioned below in the description of the figures and/or merely shown in the figures may be used not only in the combination specified, but also in other combinations or alone, without departing from the scope of the invention. The invention should therefore also be considered to comprise and disclose embodiments that are explicitly not shown or explained in the figures, but emerge and can be created from the explained embodiments by separate feature combinations.

### BRIEF DESCRIPTION OF THE FIGURES

Exemplary embodiments of the invention are illustrated in the drawings and will be described in greater detail below. In the drawings, identical reference numerals designate components or elements that perform identical or analogous functions. In the figures:

FIG. 1 shows a schematic and partial representation of a vehicle according to the invention having an exemplary embodiment of an arrangement for load distribution according to the invention in a vehicle;

FIG. 2 shows a detailed view II from FIG. 1.

### DETAILED DESCRIPTION

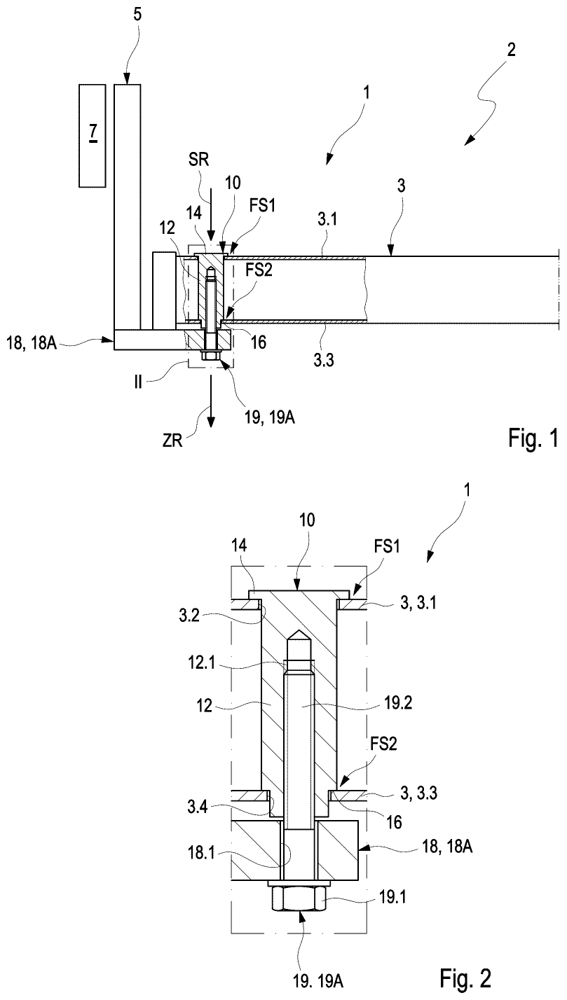

As is apparent from FIGS. 1 and 2, the illustrated exemplary embodiment of a vehicle 2 according to the invention has, in the detail shown, a longitudinal member 3 designed as a hollow profile and a cross member 5, which are connected to one another via an arrangement 1 according to the invention for load distribution.

As is furthermore apparent from FIGS. 1 and 2, the illustrated exemplary embodiment of the arrangement 1 according to the invention for load distribution in a vehicle 2 comprises the longitudinal member 3 designed as a hollow profile, a fastening sleeve 10, and the cross member 5, which has at least one fastening flange 18. The at least one fastening flange 18 of the cross member 5 extends at least in some sections parallel to the longitudinal member 3 and is connected to the fastening sleeve 10. Here, the fastening sleeve 10 is inserted into the longitudinal member 3 and connected to the longitudinal member 3 in a formfitting manner such that the fastening sleeve 10 extends parallel to the cross member 5 and introduces acting tensile loads into the longitudinal member 3.

As is furthermore apparent from FIGS. 1 and 2, the fastening sleeve 10 passes through a first opening 3.2 in an inner wall 3.1 of the longitudinal member 3 and a second opening 3.4 in an outer wall 3.3 of the longitudinal member 3. The fastening sleeve 10 is inserted into the longitudinal member 3 in the insertion direction SR, wherein the fastening sleeve 10 is first inserted into the first opening 3.2 of the inner wall 3.1 and then into the second opening 3.4 of the outer wall 3.3. The fastening sleeve 10 comprises a base body 12, which has a support plate 14 at one end and a shoulder 16 at the other end. In the fully inserted state shown, the support plate 14 rests on the edge of the first opening 3.2 and forms a first form fit FS1 with the inner wall 3.1 of the longitudinal member 3. The shoulder 16 of the fastening sleeve 10 rests on the edge of the second opening 3.4 and forms a second form fit FS2 with the outer wall 3.2 of the longitudinal member 3.

As is furthermore apparent from FIGS. 1 and 2, the at least one fastening flange 18 comprises a fastening tab 18A, which is connected to the fastening sleeve 10 at one end via suitable fastening means 19. In the exemplary embodiment shown, the base body 12 of the fastening sleeve 10 has an internal thread 12.1 and the fastening means 19 is designed as a screw 19A. Therefore, the fastening tab 18A is screwed to the fastening sleeve 10 in the illustrated exemplary embodiment. For this purpose, a threaded shaft 19.2 of the screw 19A is guided through an opening 18.1 in the fastening tab 18A and screwed into the internal thread 12.1 of the fastening sleeve 10 until a screw head 19.1 rests on an edge of the opening 18.1 with a predeterminable torque. At the other end, the fastening tab 18A is welded to the cross member 5 in the exemplary embodiment shown. Of course, other suitable connection technologies can also be used to connect the fastening tab 18A to the cross member 5.

As is furthermore apparent from FIG. 1, the longitudinal member 3 is not directly hit in the event of a frontal collision with a deformable obstacle 7 shown and initially remains undeformed. However, the impact of the cross member 5 on the obstacle causes a tensile load on the fastening sleeve 10 in the traction direction ZR via the fastening tab 18A and the screw 19A, which corresponds to the insertion direction SR of the fastening sleeve 10. Here, the tensile load is introduced and distributed into the inner wall 3.1 of the longitudinal member 3 via the first form fit FS1, and is introduced and distributed into the outer wall 3.2 of the longitudinal member 3 via the second form fit FS2. Through the form-fitting fastening sleeve 10 inserted into the longitudinal member 3, the components affected by the impact are additionally screwed to the longitudinal member 3. This allows the load to be distributed over more components and the load on the affected components to be reduced. The impact energy is distributed via the form fit to the inner wall 3.1 and the outer wall 3.2 for optimal energy dissipation, wherein the longitudinal member 3 deforms or can be deformed to dissipate energy.

### LIST OF REFERENCE SIGNS

1 arrangement for load distribution
2 vehicle
3 longitudinal member
3.1 inner wall
3.2 first opening
3.3 outer wall
3.4 second opening
5 cross member
7 obstacle
10 fastening sleeve
12 main body
12.1 internal thread
14 support plate
16 shoulder
18 fastening flange
18A fastening tab
18.1 opening
19 fastening means
19A screw
19.1 screw head
19.2 threaded shaft
SR insertion direction
ZR traction direction
FS1 first form fit
FS2 second form fit

1-8. (canceled)

9. An arrangement for load distribution in a vehicle, having a longitudinal member designed as a hollow profile, a fastening sleeve, and a cross member which has at least one fastening flange, wherein the at least one fastening flange of the cross member extends at least in some sections parallel to the longitudinal member and is connected to the fastening sleeve, wherein the fastening sleeve is inserted into the longitudinal member and connected in a formfitting manner to the longitudinal member in such a way that the fastening sleeve extends parallel to the cross member and introduces acting tensile loads into the longitudinal member.

10. The arrangement according to claim 9, wherein the fastening sleeve passes through a first opening in an inner wall of the longitudinal member and a second opening in an outer wall of the longitudinal member.

11. The arrangement according to claim 10, wherein the fastening sleeve has a support plate at one end, which rests on the edge of the first opening and forms a first form fit with the inner wall of the longitudinal member.

12. The arrangement according to claim 10, wherein the fastening sleeve has a shoulder at the other end, which rests on the edge of the second opening and forms a second form fit with the outer wall of the longitudinal member.

13. The arrangement according to claim 9, wherein the at least one fastening flange comprises a fastening tab.

14. The arrangement according to claim 13, wherein the fastening tab is screwed to the fastening sleeve at one end.

15. The arrangement according to claim 13, wherein the fastening tab is welded to the cross member at the other end.

16. A vehicle having a longitudinal member designed as a hollow profile and a cross member, which are connected to one another via an arrangement for load distribution according to claim 9.

17. The arrangement according to claim 11, wherein the fastening sleeve has a shoulder at the other end, which rests on the edge of the second opening and forms a second form fit with the outer wall of the longitudinal member.

18. The arrangement according to claim 10, wherein the at least one fastening flange comprises a fastening tab.

19. The arrangement according to claim 11, wherein the at least one fastening flange comprises a fastening tab.

20. The arrangement according to claim 12, wherein the at least one fastening flange comprises a fastening tab.

21. The arrangement according to claim 14, wherein the fastening tab is welded to the cross member at the other end.
